(19) United States
(12) Patent Application Publication
(10) Pub. No.: US 2006/0181872 A1
(43) Pub. Date: Aug. 17, 2006

(54) Apparatus and method for illuminating a rod

(75) Inventor: Michael Pashley, Cortlandt Manor, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/539,966

(22) PCT Filed: Dec. 12, 2003
(86) PCT No.: PCT/IB03/06020

§ 371 Date: Jun. 19, 2005

Related U.S. Application Data
(60) Provisional application No. 60/435,245, filed on Dec. 20, 2002.

(51) Int. Cl. F21V 9/00; F21V 1/00; F21V 11/00

(52) U.S. Cl. 362/231; 362/235

(57) ABSTRACT

The invention provides an apparatus that illuminates a rod (130) comprising a plurality of light emitting diode chips (110), the light emitting diode chips (110) forming at least one multi-chip package; at least one reflector (120), the reflector optically connected to the multi-chip package (110); and an output rod (130), the output rod optically connected to the reflector (120).

In general, the invention relates to optical fiber and optical rod illumination. More specifically, the invention relates to light engines used to illuminate optical fibers and optical rods, and in particular, to an LED based Light Engine for optical fiber and optical rod illumination using a multi-chip package.

Light engines are used in conjunction with fibers and rods for illumination purposes. Conventional light sources (halogen lamps or HID lamps) are normally used as the light source. More recently, light emitting diode (LED) based microchips (chips) have been used as a light source for light engines. The typical LED based light engine includes multiple single LED chip packages, each connected to a collimator optic. The light engine is completed with the inclusion of a single condenser lens for directing the light from the multiple chip packages and collimator optics to an output (optical) fiber or rod.

While this design has been shown to work with reasonable efficiency (70% of the light emitted by the LEDs can be made to enter the rod), it is bulky and expensive. In a light engine with 18 LEDs that has been built, the rod is 20 mm in diameter, and the light engine is over 80 mm wide and 100 mm in length. Further, the optical components required, (18 LED chips, 18 collimator optics, and 1 condenser lens) are costly, with the price and size increasing as the number of LED chips and collimator optics increases.

Thus, there is a significant need for an apparatus and method for optical fiber and optical rod illumination that overcomes the above disadvantages and shortcomings, as well as other disadvantages.

One aspect of the invention presents a light emitting diode light engine for illuminating a rod. The light emitting diode light engine comprises a plurality of light emitting diode chips, the light emitting diode chips forming at least one multi-chip package; at least one reflector, the reflector optically connected to the multi-chip package; and an output rod, the output rod optically connected to the reflector.

Another aspect of the invention presents a method for illuminating a rod by illuminating a plurality of light emitting diode chips on at least one multi-chip package; transmitting light from the multi-chip package to at least one reflector; and providing the reflected light to an output rod.

Another aspect of the invention presents a light emitting diode system. The system comprises means for emitting light; means for reflecting the emitted light; and means for receiving and outputting the reflected light.

The foregoing and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

FIG. 1 is a schematic diagram illustrating one embodiment of a light engine, in accordance with the present invention;

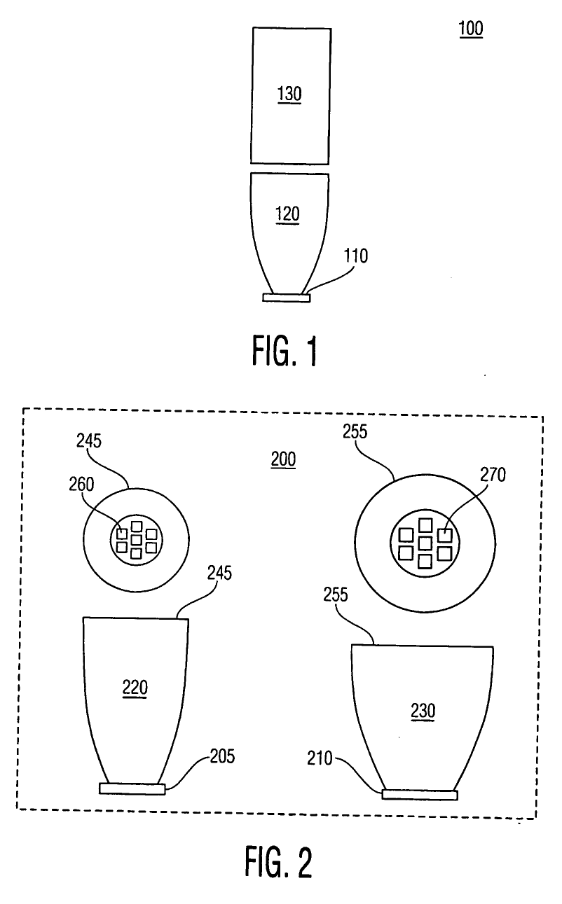

FIG. 2 is a schematic diagram illustrating one embodiment of light engine efficiency, in accordance with the present invention; and

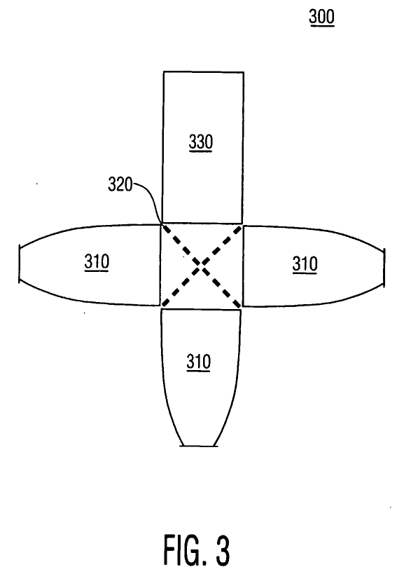

FIG. 3 is a schematic diagram illustrating one embodiment of a multi-color light engine, in accordance with the present invention.

In FIG. 1, one embodiment of a light engine optical system 100, also known as a light engine, is illustrated in accordance with the invention. In FIG. 1, a light emitting diode chip (LED) multi-chip package 110 is shown. One embodiment of the invention provides that the multi-chip package is specifically designed for light engine applications where it is desired to illuminate at least one rod 130. The rod 130 may be of rigid construction or may be flexible. Further, the rod 130 may be in reference to a fiber or bundle of rods, bundle of fibers, or bundle of rods and fibers.

Another embodiment of the multi-chip package 110 contains LED chips (chips) that are closely spaced, and in a further embodiment of the invention, can have one or more single color or two or more different color chips in the same package. The color chips provide a multi-color, variable color, white light, or controlled white light source. A further embodiment of the multi-chip package 110 has the chips in an array formation, and in one embodiment of the white light version of the invention, chips provide the three primary colors (red, green, and blue). Additionally, an embodiment of the multi-chip package 110 can be used with any number of different colors, as application needs arise. In addition, embodiments of the invention arrange the chips in a two-dimensional plane layout on a highly reflective substrate and may be strategically placed or in a mathematically aligned array format. For another embodiment of the invention, it is important that the specific details of the array pattern, for example the symmetry and average radial distance for the chip layout, be carefully matched to specific reflector designs.

In yet another embodiment of the multi-chip package 110, feedback sensors and/or control electronics are included and are in communication with the LED chips.

A reflector 120 is optically connected to the multi-chip package 110 and designed to direct the light from the multi-chip package 110 into the rod 130, also known as an output rod. One embodiment of the reflector 120 provides for the light to be directed to the rod 130 within an acceptance angle specific to the rod 130, and as is known in the art. The reflector 120 is located in optical communication between the multi-chip package 110 and the rod 130. In another embodiment of the invention, the reflector 120 is part of the multi-chip package 110, and in yet another embodiment of the invention, the multi-chip package 110 requires at least part of the reflector 120 to function.

The multi-chip package 110 and reflector 120 afford a reduction in the size of the light engine 100 over conventional light engines. By using a suitably designed multi-chip package 110, the diameter of the optical system (maximum diameter of the chip placement) can be limited to the diameter of the output rod or fiber 130. This is achieved while maintaining, or even increasing, the optical efficiency of the system and maintaining the light flux that is directed into the fiber or rod 130.

In FIG. 2 is a schematic diagram illustrating one embodiment of light engine efficiency 200. Typically, the rod (or fiber) relies on total internal reflection (TIR) to transmit light along the rod. The angular distribution must be within the limits for maintaining TIR inside the rod. This is typically a cone angle of between 2×30° and 2×40°. For high efficiency, the reflector walls should have a high reflectivity (90% or more). The precise shape of the reflector can be optimized for the array of LED chips, and in one embodiment of the invention, can be a Compound Parabolic Reflector (CPC) as is known in the art. The CPC can be designed to maximize the coupling of light from the multi-chip package into the output rod, with the required cone angle. Very high incoupling efficiency can be achieved (over 80%) if the LED chips are restricted in size and/or number so that the multi-chip package etendue does not exceed the input etendue of the output rod. Increasing the number or size of the LED chips can increase the total input flux. The CPC reflector is then slightly shorter and has a larger input aperture (i.e. maximum chip layout diameter). The incoupling efficiency of the CPC reflector will be reduced, but there will be a net gain in light in the output fiber. The above description for one embodiment of efficiency is further evident in FIG. 2.

The output apertures 245 and 255 are equal to the output rod diameter. Multi-chip packages 205 and 210 are at the base of CPC reflectors 220 and 230, respectively. In this embodiment, the taller of the two CPC reflectors is illustrated as 220. When viewed from the top, the diameter of the LED arrays (260 for multi-chip package 205, and 270 for multi-chip package 210) used in this embodiment show the larger LED array to be 270. The larger LED array 270 is less efficient than the smaller LED array 260 because the shortened CPC reflector 230 produces a larger angular distribution than the CPC reflector 220, CPC reflector 220 being more efficient for incoupling to the rod.

Another embodiment of the present invention, a multi-color light engine 300 is shown in the schematic diagram of FIG. 3. In this application, the multi-chip packages are in optical communication with the reflectors to form the singular light engines 310. The single color versions of these multi-chip packages can be used together with a standard dichroic cube 320 to couple red green and blue light into the output rod 330 to generate white light. This can increase the light that can be incoupled by more than a factor of two compared with a multi-color package designed for the same white point.

The above-described apparatus and methods for illuminating a rod are example apparatus and methods. These apparatus and methods illustrate one possible approach for multi-chip package illumination of an output rod. The actual implementation may vary from the method discussed. Moreover, various other improvements and modifications to this invention may occur to those skilled in the art, and those improvements and modifications will fall within the scope of this invention as set forth below.

The present invention may be embodied in other specific forms without departing from its spirit or essential characteristics. The described embodiments are to be considered in all respects only as illustrative and not restrictive.

1. An apparatus for illuminating a rod comprising:
a plurality of light emitting diode chips, the light emitting diode chips forming at least one multi-chip package 110;
at least one reflector 120, the reflector 120 optically connected to the multi-chip package 110; and
an output rod 130, the output rod 130 optically connected to the reflector 120.

2. The apparatus of claim 1 wherein the reflector 120 directs light emanating from the light emitting diode chips.

3. The apparatus of claim 1 wherein the output rod 130 receives light emanating from the light emitting diode chips and light reflected by the reflector 120.

4. The apparatus of claim 1 wherein the output rod 130 is flexible.

5. The apparatus of claim 1 wherein the light emitting diode chips are positioned on the multi-chip package forming an array 260.

6. The apparatus of claim 1 wherein the maximum diameter of the multi-chip package 260 is equal to the input etendue of the output rod 130.

7. The apparatus of claim 1 wherein the reflector output aperture 245 is equal to the input diameter of the output rod 130.

8. The apparatus of claim 1 wherein the reflector 120 is a compound parabolic reflector 220.

9. The apparatus of claim 1 wherein the reflector 120 provides total internal reflection.

10. The apparatus of claim 1 further comprising:
a plurality of multi-chip packages 310 and a plurality of reflectors 310, the multi-chip packages 310 optically connected to the reflector 310; and
a dichroic cube 320, the dichroic cube 320 optically connected to the reflectors 310 and the output rod 330.

11. The apparatus of claim 10 wherein the plurality of multi-chip packages 310 emanate red, green, and blue light.

12. The apparatus of claim 10 wherein the dichroic cube 320 couples red, green, and blue light into the output rod 330 to generate white light.

13. A method for illuminating a rod comprising:
forming at least one multi-chip package from a plurality of light emitting diode chips;
transmitting light from the multi-chip package to at least one reflector; and
providing the light from the reflector to an output rod.

14. The method of claim 13 wherein the maximum etendue of the multi-chip package is equal than the input etendue of the output rod.

15. The method of claim 13 further comprising:
providing colored light from at least two multi-chip packages;
transmitting the colored light from the multi-chip packages to at least two reflectors;
providing the colored light from the reflectors to a dichroic cube;
generating a white light from the colored light as a function of the dichroic cube; and
providing the white light from the dichroic cube to the output rod.

16. The method of claim 15 wherein the colored light is directed by one reflector.

17. The method of claim 15 wherein the white light is generated from red, green, and blue light.

18. A system for illuminating a rod comprising:
means for forming at least one multi-chip package from a plurality of light emitting diode chips;
means for transmitting light from the multi-chip package to at least one reflector; and
means for providing the light from the reflector to an output rod.

19. The system of claim 18 further comprising:
means for providing colored light from at least two multi-chip packages;
means for transmitting the colored light from the multi-chip packages to at least two reflectors;
means for providing the colored light from the reflectors to a dichroic cube;
means for generating a white light from the colored light as a function of the dichroic cube; and
means for providing the white light from the dichroic cube to the output rod.
